(19) United States
(12) Patent Application Publication
(10) Pub. No.: US 2025/0074673 A1
(43) Pub. Date: Mar. 6, 2025

(54) STORAGE CONTAINER WITH RECESSED CAVITIES FOR REARRANGEMENT

(71) Applicant: Bombardier Recreational Products, Inc., Valcourt (CA)

(72) Inventors: Clement Tavernier, Sherbrooke (CA); Gregoire Mimeault, Eastman (CA)

(21) Appl. No.: 18/822,046

(22) Filed: Aug. 30, 2024

Related U.S. Application Data
(60) Provisional application No. 63/579,828, filed on Aug. 31, 2023.

(51) Int. Cl. B65D 55/02; B65D 25/28

(52) U.S. Cl. CPC B65D 55/02; B65D 25/2841

(57) ABSTRACT

A storage container comprises an outer surface and an inner surface, the outer surface having one or more cavities. A locking mechanism may be located in a cavity disposed on the bottom of the storage container and have arms to allow for locking and unlocking of the same despite the distal positioning of the locking mechanism form the outer surface of the container. Handles may be hingedly located within a cavity in the outer side surface of the container and can be moved into holding positions and back.

### RELATED APPLICATIONS

This application claims the benefit of priority of U.S. Provisional Patent Application Ser. No. 63/579,828, filed on Aug. 31, 2023, the entire disclosures of which being incorporated herein by reference in their entirety.

### FIELD OF THE INVENTION

The present invention relates to anchoring mechanisms for storage containers for use on vehicles designed to traverse rough and/or uneven terrain, such as snowmobiles, ATVs, personal watercraft and the like.

### BACKGROUND

The use of anchors for holding storage containers is known and subsists in prior patents for the same, such as, for example, U.S. Pat. No. 8,777,531 and the Linq® anchor system made and sold by Bombardier Recreational Products, Inc. of Valcourt, Quebec, the disclosures of each of which being incorporated herein by reference in their entirety.

Despite these anchors, there still exists a need by users to rearrange the storage containers which uses these anchors within their vehicles.

### SUMMARY

An exemplary anchor assembly for storage containers may comprise an outer surface and an inner surface into which objects may be contained. In an exemplary anchor assembly for storage containers the outer surface may have an outer side surface and a bottom surface so that at least one first cavity in one of the outer side surface and the bottom surface has disposed within it at least one locking mechanism. An exemplary locking mechanism may comprise a rotatable key for reception within an anchor having a corresponding opening for said key and an arm extending outwardly from the locking mechanism that is configured to rotate the key. An exemplary key arm may span a distance that is bounded by a surface of the at least one first cavity.

In addition to the previously described embodiment and/or as an alternative to any other described exemplary embodiment, an exemplary anchor assembly for storage containers may further comprise at least one second cavity located on the bottom surface opposite the location of the at least one first cavity.

In addition to the previously described embodiment and/or as an alternative to any other described exemplary embodiment, an exemplary anchor assembly for storage containers may further comprise an adjustable handle hingedly coupled to the storage container within the at least one second cavity, wherein the handle comprises a slot in which a portion of the storage container may travel and a surface on the handle most proximal to the at least one second cavity that enables substantially orthogonal and fixed placement of the handle vis-à-vis the outer surface of the storage container.

In addition to the previously described embodiment and/or as an alternative to any other described exemplary embodiment, an exemplary anchor assembly for storage containers may further comprise at least one third cavity located on the bottom surface opposite the location of the at least one first cavity, the at least one second cavity comprising a locking mechanism having at least one arm configured to rotate a rotatable key of the locking mechanism.

In addition to the previously described embodiment and/or as an alternative to any other described exemplary embodiment, an exemplary anchor assembly for storage containers may further comprise at least one fourth cavity located on the outer side surface opposite the location of the at least one second cavity, the at least one fourth cavity comprising an adjustable handle hingedly coupled to the storage container within the at least one fourth cavity.

In addition to the previously described embodiment and/or as an alternative to any other described exemplary embodiment, an exemplary anchor assembly for storage containers may be configured such that the at least one first cavity is located on the bottom surface of the storage container.

In addition to the previously described embodiment and/or as an alternative to any other described exemplary embodiment, an exemplary anchor assembly for storage containers may be configured such that a second cavity comprises a locking mechanism having at least one arm configured to rotate a rotatable key of the locking mechanism.

In addition to the previously described embodiment and/or as an alternative to any other described exemplary embodiment, an exemplary anchor assembly for storage containers may be configured such that the at least one first cavity is located on the bottom surface of the storage container and the storage container comprises at least one second cavity located on the outer side surface of the storage container.

In addition to the previously described embodiment and/or as an alternative to any other described exemplary embodiment, an exemplary anchor assembly for storage containers may be configured such that the locking mechanism in the at least one first cavity and the locking mechanism in the at least one second cavity are located along a line that is substantially collinear with a major horizontal dimension of the storage container.

In addition to the previously described embodiment and/or as an alternative to any other described exemplary embodiment, an exemplary anchor assembly for storage containers may be configured such that the locking mechanism in the at least one first cavity and the locking mechanism in the at least one third cavity are located along a line that is substantially collinear with a major horizontal dimension of the storage container.

In addition to the previously described embodiment and/or as an alternative to any other described exemplary embodiment, an exemplary anchor assembly for storage containers may be configured such that the locking mechanism in the at least one first cavity and the locking mechanism in the at least one third cavity are located along a line that is substantially collinear with a line that divides each handle in half.

### DESCRIPTION OF THE DRAWINGS

FIG. 1A illustrates an exemplary top view of an exemplary cargo space holding a storage container in one arrangement via a plurality of anchors.

FIG. 1B illustrates an exemplary top view of an exemplary cargo space holding a storage container in a second arrangement via the plurality of anchors in FIG. 1A.

FIG. 1C illustrates an exemplary set of anchors for use in holding an exemplary storage container in various arrangements.

FIG. 1D illustrates an exemplary anchor and tongue for use in holding an exemplary storage container in various arrangements.

FIGS. 2A-B illustrate an exemplary operational depiction of an exemplary anchoring arrangement on an exemplary storage container to enable multivarious locking and unlocking to a plurality of anchors in an exemplary cargo space.

FIG. 3 illustrates an exemplary handle and accessory system for use in an exemplary container system.

FIGS. 3A-D illustrate a pictorial methodology for the re-arrangement of an exemplary handle of a storage container.

FIG. 3E illustrates an alternative view of an exemplary handle and accessory system for use in an exemplary storage container.

In the drawings like characters of reference indicate corresponding parts in the different and interchangeable and interrelated figures. Parts and components of each figure may be substitutes for other components in other figures to achieve the various methods and embodiments disclosed herein. Methods and protocols disclosed in any embodiment may be run in any order so as to affect their disclosed goals and/or enable performance of the systems as described. Additionally, any one embodiment may utilize any method or protocol described and in any portions, sequences, and combinations thereof.

### DETAILED DESCRIPTION

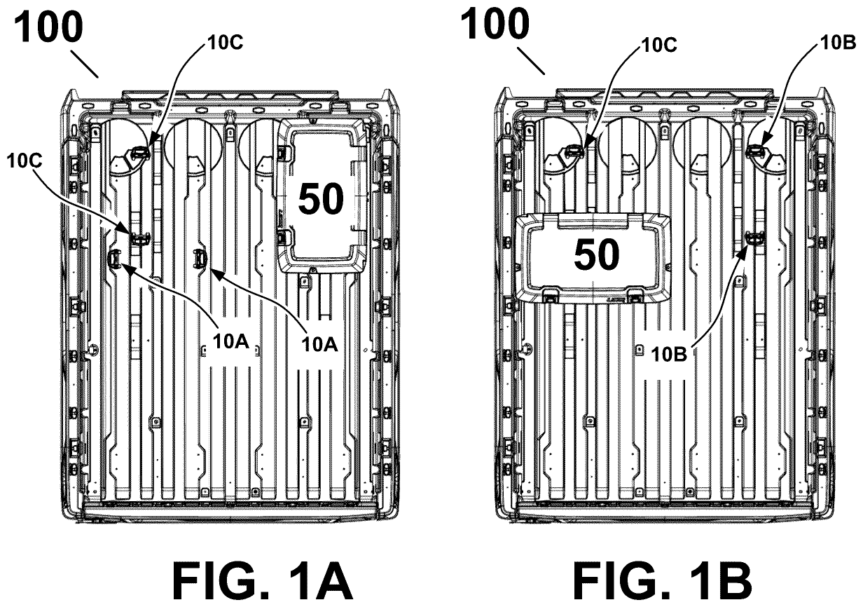

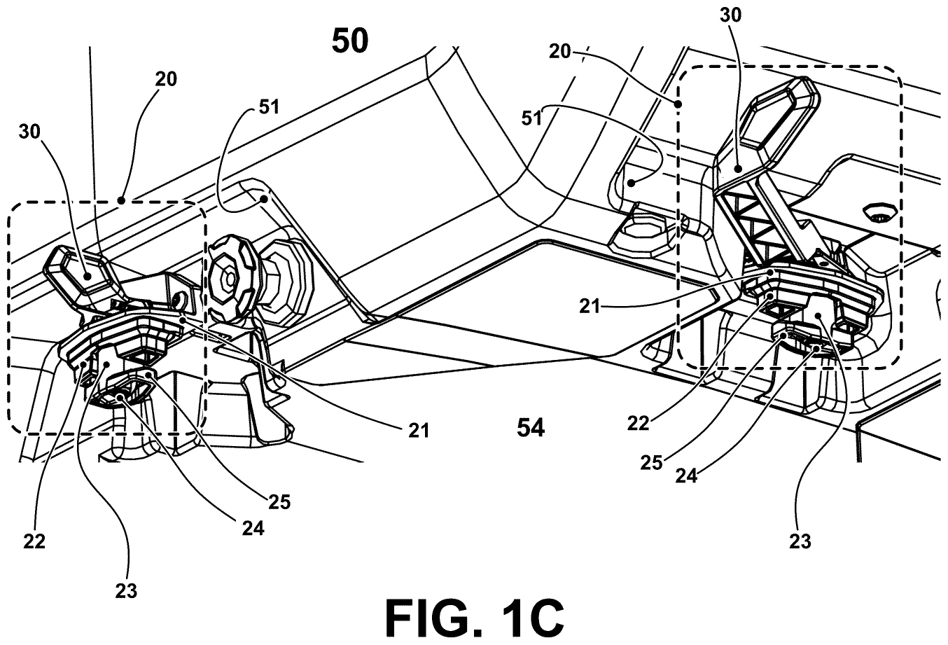

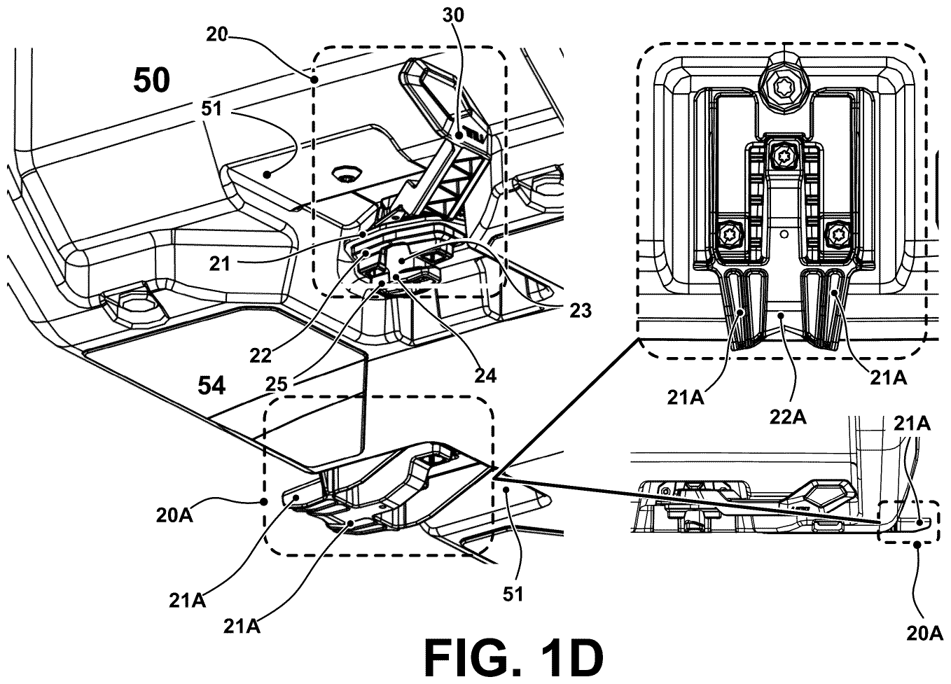

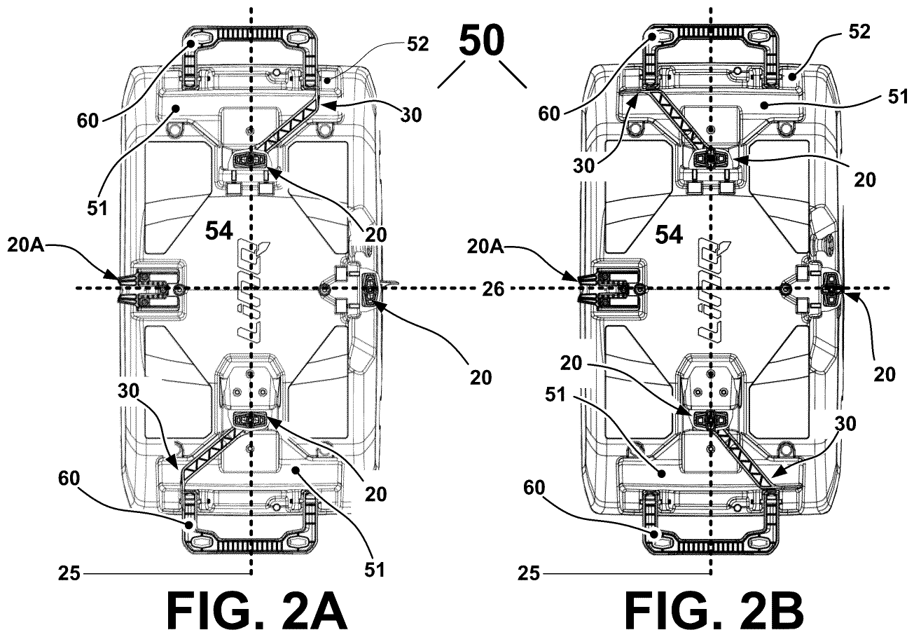

Referring to FIGS. 1A-B, an exemplary cargo space 100 may comprise at least one container 50 and a plurality of anchors 10A, 10B, and 10C as are known to those skilled in the art. As has been known, in order to remove the storage container 50 from one portion of a cargo space 100 to another portion, it may have been necessary to ensure proper placement of the anchors 10A-C to enable re-organization and re-arrangement of the container 50 without the need to rearrange and reconfigure the anchors 10A-C in the storage space 100. As illustrated in FIGS. 1A-B, each of anchors 10A-C have been already assembled with the proper arrangement and organization to affect the removal and re-arrangement of the container 50 within that space. In an exemplary embodiment, an exemplary arrangement of anchors 10A-C may be achieved at the manufacturing level or the customer installation level, namely, at the point at which the cargo space 100 is made so that the anchors 10A-C are in the locations that would permit such a container 50 to be moved and reorganized as needed.

Referring to the illustrative embodiment of FIG. 1C, an exemplary container 50 may be shown with two different types of anchoring mechanisms 20 found within cavities 51 in the container outer surface and proximal to the bottom surface 54 of the container, e.g., that surface of an exemplary container 50 which most typically would be placed on a storage surface 100 when at rest. Each exemplary mechanism 20 may comprise a body 21 which mechanically or integrally couples the remainder of the mechanism to the container 50. Each exemplary mechanism 20 may comprise an envelope 22 extending from the body 21. An exemplary envelope 22 may be dimensioned to fit within one or more anchors 10A-C disposed on a storage surface 100. In other words, envelope 22 may allow for engagement between the anchoring mechanism 20 (and thusly the storage container 50) prior to any further locking engagements being made.

As previously referred to in the discussion of the anchoring mechanism 20 of FIG. 1C, an exemplary mechanism 20 may have a neck 23 resiliently attached to the body 21 of the mechanism to enable a spring-type coupling between the portions attached to and including neck 23 and the remainder of body 21. In other words, within body 21 may be a spring or other type of resilient structure that can undergo deformation but return to its at-rest (pre-deformation) configuration. An exemplary neck 23 may be integrally molded with a head 24 designed to also fit within an appropriately designed recess in the anchor 10A-C in like fashion to envelope 22. In an alternative embodiment, only the head 24 may have the corresponding shape to engage an anchor 10A-C while envelope 22 does not. In yet another alternative embodiment, envelope 22 may have a first shape corresponding to the opening of anchor 10A-C and head 24 may have a smaller-sized shape corresponding to that same anchor 10A-C opening. For example, an exemplary envelope 22 may have hexagonal cross section that is larger than a hexagonal cross-section of head 24, both of which being designed to be inserted into a hexagonal opening in an anchor 10A-C. With continued reference to FIG. 1C, an exemplary anchoring mechanism 20 may further comprise a protrusion 25 coupled to the head 24 of an exemplary mechanism 20. An exemplary protrusion 25 may have a portion of the cross-section of the anchor 10A-C but be configured to otherwise pass through a first section of the anchor 10A-C to then allow itself to be turned underneath the section and thereby lock mechanism 20 (and thusly container 50) to the same. Components 23, 24, and 25 of an exemplary locking mechanism 20 may collectively be referred to as the “key” component of the locking mechanism 20 disclosed and described herein.

Still referring to FIG. 1C, an exemplary container 50 may have arms 30 interconnected to each locking mechanism 20 to enable users to displace the key left and right (e.g., within and without the anchor 10A-C). To do so, arms 30 may comprise cam-type engagements within body 21 that bias the neck 23 out of and/or away from envelope 22 when arms 30 are turned in a particular direction. As illustrated in FIG. 1C, an exemplary arm 30 is interconnected to key 25 so that rotation of one will cause equal angular displacement of the other. Thus, when an exemplary arm 30 is turned into a particular angular position (e.g., 90 degrees), the rotation of arm 30 thereby causes sloping surfaces on key 25 to turn into a locked position within the available space of a corresponding anchor 10A-C. In an exemplary aspect of this embodiment, a combination of friction and rigidity in the materials making up anchor 10A-C and key 25, such as a plastic, thermoplastic, metal, or other suitable material, combine to create a robust joint between one another to firmly affix the body 21 (and any interconnected components) to the locus of the anchor 10A-C, which can be more conveniently and efficiently achieved through the torque provided via arm 30. Alternatively, an exemplary arm 30 may be turned to a position that the internal cam pushes neck 23 away from body 21 so as to cause it to descend and expose the neck 23, head 24, and protrusion 25 for engagement with another object (e.g., anchors 10A-C). When an exemplary arm 30 is rotated to another position (e.g., the starting position) while neck 23, head 24, and protrusion 25 are already disposed within and through sections of an exemplary anchor 10A-C, the rotation of the arm may cause a similar rotation of neck 23, and thusly, head 24 and protrusion 25, so that the “key” of the mechanism 20 may tend to want to spring back to its original starting position but cannot due to the anchor 10A-C structure through which it was previously inserted. Thus, when an engaged key of an exemplary anchoring mechanism 20 is inserted into an anchor 10, the movement of arms 30 may effect a spring-loaded locking arrangement between the anchor 10A-C and the neck 23, head 24, and protrusion 25 components of the “key” of the locking mechanism 20, e.g., protrusion 25 may be inhibited from being displaced from anchor 10A-C due to the structure of the anchor 10 preventing the protrusion 25's bypass and release to its at-rest position prior to insertion in the anchor 10. As described above, the above is an exemplary locking arrangement for use within an exemplary container 50 according to embodiments herein.

Referring now to the exemplary embodiment of container 50 as illustrated in FIG. 1D. According to this exemplary embodiment, instead of a locking mechanism 20 being located orthogonally to another locking mechanism 20 (as may be illustrated in FIG. 1C), an exemplary container 50 may comprise a tongue 20A located within a cavity 51 proximal to bottom surface 54 of an exemplary container 50. In a first aspect, tongue 20A may be used to slip under and/or into a complementary space or crevice formed by the structure of an exemplary anchor 10A-C without the need for hinged-coupling (as discussed with respect to an exemplary functional operation of key components 21-25 of an exemplary locking mechanism 20). The aforementioned operative engagement may also be between the tongue 20A and a complementary space or crevice in one or more of the support surfaces 100 and other attachments thereto (e.g., racks and/or adaptors). According to this first aspect, the tongue 20A may use its side surfaces 21A to frictionally engage the anchor 10A-C surfaces to allow rigid coupling and/or fixation within the same while the remaining locking mechanisms 20 may be used to complete the securing of the exemplary container 50 to an exemplary support surface 100. The first aspect of an exemplary tongue 20A may be to permit a user to place an exemplary container 50 into a tight location for which a user may be unable to otherwise turn the handles 30 or otherwise engage the keys of locking system 20. Therefore, an exemplary tongue 20A achieves a less permanent locking configuration within relatively less accessible spaces on a support surface 100 comprising anchors 10A-C with the capability of becoming substantially more permanent after an exemplary container 50 is locked to the support surface 100 using one or more locking mechanisms 20. In an alternative aspect, tongue 20A may be useful in achieving a desired alignment of the locking mechanisms 20, and therefore container 50, within and among anchors 10A-C coupled to the support surface 100 prior to final locking of the container 50 to the same.

In a second aspect, tongue 20A may have a snap-like engagement surface 22A configured to also frictionally engage one or more surfaces and/or openings in an exemplary anchor 10A-C. The engagement surface 22A of an exemplary tongue 20A may be configured to limit the amount of play or displacement afforded an exemplary container 50 prior to locking by one or more locking mechanism 20. In an exemplary embodiment, an exemplary tongue 20A may use its engagement surface 22A in combination with its side surfaces 21A to manifest a robust coupling between the container 50 and the remainder of the support surface 100 via an anchor 10A-C, but which is not substantially rigidly fixed in place. An exemplary tongue 20A comprising such surfaces 21A/22A may enable more expedient location and alignment of an exemplary container 20 with a series of anchors 10A-C to facilitate and expedite the formation and final coupling using one or more locking mechanisms 20. According to this exemplary embodiment and aspect, use of tongue 20A may be the first step in an exemplary container 50 locking method to a support surface 100 having anchors 10A-C, which may then be followed by use of locking mechanisms 20 to complete the locked engagement between the container 50 and support surface 100.

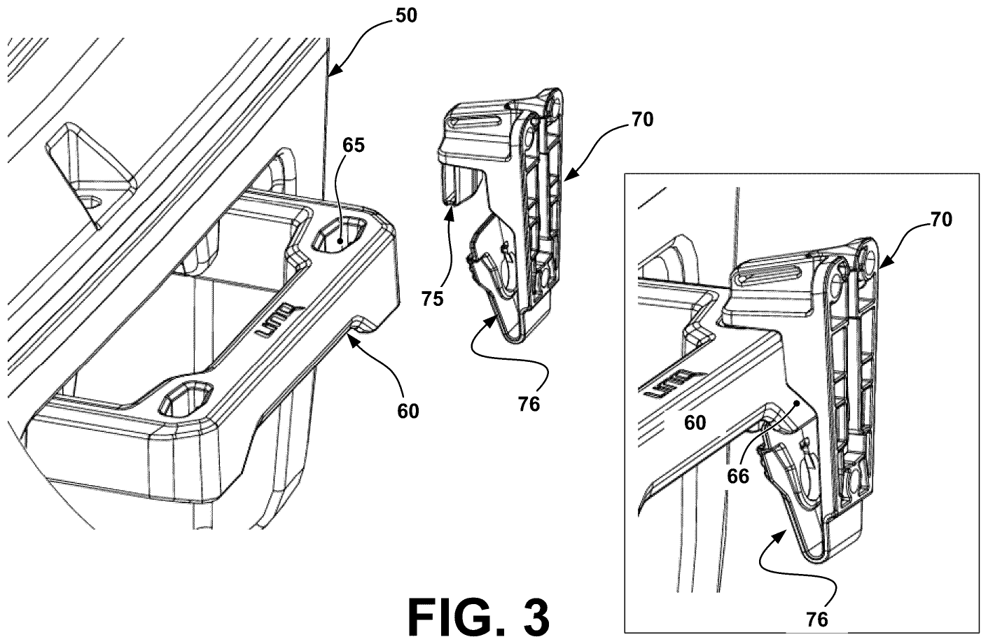

Referring now to FIGS. 2A-B, an exemplary container 50 of the type previously described may be shown on its bottom surface 54 with its handlebars 60 extended away from its side walls. A cavity 51 may be formed in portions of the bottom 54 of container 50 to accommodate the swing of arm 30 of anchoring mechanism 20 to a corresponding anchor 10A-C found in the storage space 100. An exemplary arm 30 may be a plastic extension of a surface of the anchoring mechanism that would be used to affix container 50 to an anchor 10A-C, i.e., in a storage space 100. As illustrated, FIG. 2A may show the anchoring mechanism 20 in an open configuration whereby the operative portions of mechanism 20 (e.g., neck 23, head 24, and protrusion 25) may slip into an opening in an exemplary anchor 10A-C, e.g., the hexagonal key of the mechanism 20 is at the same angle as the hexagonal opening in an anchor 10A-C with respect to line 25. As illustrated, FIG. 2B may show the anchoring mechanism 20 in a closed configuration whereby the key of the mechanism 20 may be turned substantially 90 degrees to the opening in the exemplary anchor 10A-C so as to be “locked” to the same, e.g., the hexagonal key of the mechanism 20 is less than 90 degrees with respect to line 25 while the hexagonal opening in anchor 10A-C remains at 90 degrees with respect to line 25. According to this and other exemplary embodiments, line 25 may be a line that is substantially collinear with a plane passing through a majority of the storage container 50. Alternatively, line 25 may be a line that is substantially collinear with a line that divides storage container 50 into two halves. Further alternatively, line 25 may be a line that is substantially collinear with a line that divides storage container 50 as well as handles 60. In yet another alternative arrangement, line 25 may be a line that dives container 50 along its major lateral axis between its outer walls. Furthermore, an exemplary line 25 and/or 26 may interconnect a locking mechanism 20 to a tongue 20A disposed on an exemplary container 20. In a preferred embodiment, the tongue 20A may be located on one of the longer sides of an exemplary container 50.

In an exemplary embodiment, the location of a pair of exemplary anchoring mechanisms 20 within cavities 51 of an exemplary storage container 50 may be pre-defined, e.g., being located approximately 16 inches from one another, to enable the multivarious placement of the container 50 within a given storage space 100. Additionally, use of exemplary arms 30 of an exemplary storage container 50 may enable case of removal of an exemplary container 50 from anchors 10A-C located inwardly of the outer walls of the container 50. In this way, arms 30 may enable case of attachment and detachment of container 50 from an exemplary storage space 100 anchors 10A-C without the need to reach under the container. In other words, each of the arms 30 enable an indirect method by which the anchoring mechanism 20 may be activated from a point distal to the point at which its key is turned either 90 degrees to line 25 and/or less than 90 degrees to line 25.

In an exemplary embodiment, the distance between anchoring mechanisms 20 along line 25 may be the same as the distance between anchoring mechanisms along line 26. According to such an exemplary embodiment, a storage container 50 comprising such equidistant but orthogonal or otherwise arranged anchoring mechanism 20 may be capable of various positions and fixation within a storage space 100 due to the fact that anchoring mechanisms 20 remain relatively positioned with respect to one another about the container 50. In yet another alternative embodiment, the distance between anchoring mechanisms 20 along line 25 and/or line 26 may be substantially the same, e.g., 16 inches. While lines 25 and 26 may be shown orthogonal to one another, they need not be so depending on the type of container 50.

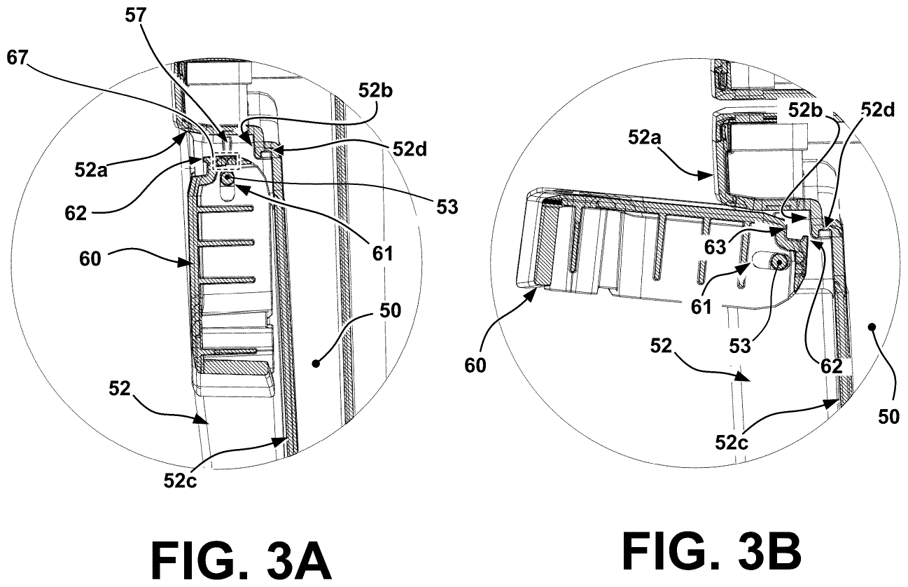

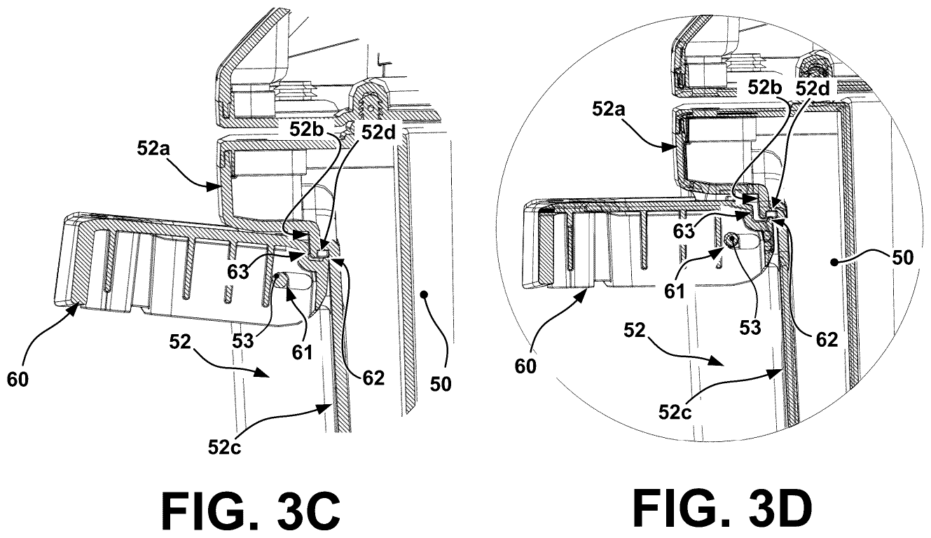

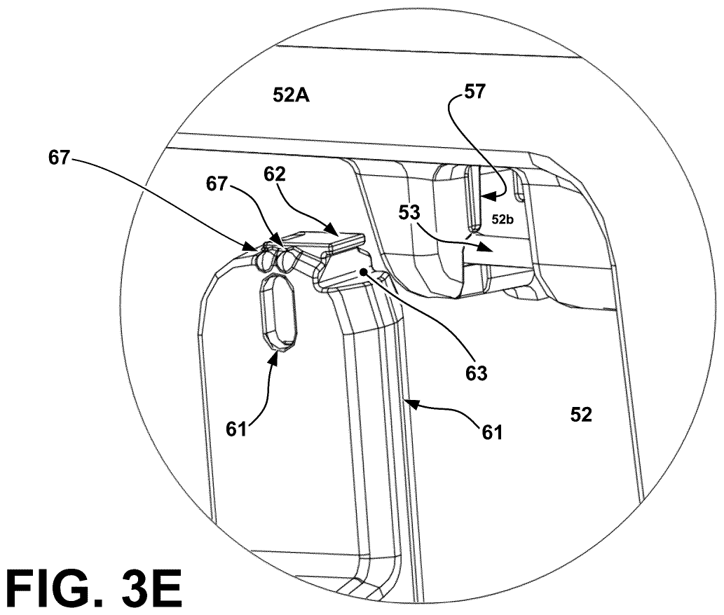

An exemplary storage container 50 may also have a handle 60 hingedly fixed thereto, as may be illustrated in FIG. 3. As illustratively provided for in FIG. 3, an exemplary storage container 50 and exemplary handle 60 may have within it a cavity 65 configured to receive at least one accessory 70 bearing a complimentary tab 75. In an exemplary embodiment, cavity 65 may be the same type of opening used for receipt of various other types of locking engagements, such as, for example, the hexagonal key of mechanism 20 or alternatively sized keys of similar or different cross-sections. Additionally, as illustrated in FIG. 3, an exemplary accessory 70 may also have a resistance clip 76, which may be used to snap the accessory 70 onto an exemplary handle 60 via a post 66 when received within cavity 65 so as to substantially resist displacement of the accessory 70 during container 50 movement. While not shown, an exemplary accessory 70 may be connected to another object, such as, for example, a cup holder, a tool, an electronic device, and other portable and/or non-portable apparatus. Furthermore, when applicable, deflecting a portion of clip 76 may allow for a user to remove accessory 70 from its reception within cavity 65 and completely remove the same from handle 60 of container 50. In an alternative embodiment, an exemplary accessory 70 may not have a clip 76 but instead have a rotational joint between tab 75 and the body of accessory 70. An exemplary rotational joint may allow the accessory 70 to maintain its engaged angular position (i.e. the position it has when tab 75 is engaged in cavity 65) while handle 60 of container 50 is rotated from being substantially parallel to the support surface of cavity 50 to a position that is substantially perpendicular to the support surface of cavity 50. Thus, according to this exemplary alternative embodiment, accessory 70 may not need to be disengaged from handle 65 despite handle 65 being moved vis-à-vis the support surface of container 50.

With reference to the illustrative embodiments of FIGS. 3A-D, an exemplary handle 60 of an exemplary storage container 50 may be shown in profiled and sectional view to enable discussion of operation of the same. As depicted in FIG. 3A, an exemplary handle 60 may be shown at rest so that its top surface may be substantially aligned with the outer-most surface 52a of storage container 50, while the remainder of the handle 60 may be located within a cavity 52 of storage container 50 in near contact with cavity wall 52c. Exemplary handle 60 may be hingedly attached to storage container 50 by way of a slot 61 and pin 53 combination, the pin 53 being a part of the storage container 50. As may be further illustrated in FIG. 3A, an exemplary cavity 52 in an exemplary container 50 may also have a groove 52d in a staggered wall 52b descending from the surface of cavity 52 most proximal to container surface 52a. In an exemplary embodiment, groove 52d may be configured to receive a surface 62, as will be illustrated in FIGS. 3C-D. Exemplary handle 60 may be held in place within the cavity 52 by way of a friction-fit connection between opposing corrugations 67 on the apex of the handle 60 (e.g., the surface most distal and aligned with the major length of slot 61). In an exemplary embodiment, ridges 67 frictionally engage a ridge 57 located on the interior surface of the rotation zone for handle 60 within cavity 52. The aforementioned instrumentalities may be better understood with reference to FIG. 3E, which may illustrate a closer view of the opposite side of handle 60 facing toward the internal surface of cavity 52, which is out of view in FIG. 3A. As illustrated, corrugations 67 may be shown as integrally-molded features of handle 60. The spacing of each corrugation 67 vis-à-vis one another and also at the apex of handle 60 may allow handle 60 to flexurally engage ridge 67. In an exemplary embodiment, corrugations 67 may be spaced and oriented on handle 60 so that when handle 60 is at rest, each opposing corrugation 67 prohibits rotational of handle 60 due to the friction-induced relationship. In a preferred embodiment, the space between corrugations 67 may be sufficient to frictionally hold handle 60 in a substantially vertical position (i.e., substantially parallel to wall 52c of cavity 52).

Referring to FIG. 3B, an illustrative handle 60 may be shown in a raised configuration such that the pin 53 may permit rotation of the handle 60 from a position substantially parallel to cavity 52 wall 52c to a position substantially orthogonal to the same. In this arrangement as illustrated in FIG. 3B, an exemplary surface 63 in an exemplary handle 60 may be substantially parallel to the wall 52b of cavity 52. At the position shown in FIG. 3B, an exemplary handle 60 may be in a position so that pin 53 may allow sliding of handle 60 towards cavity 52 along slot 61 of the handle 60. An exemplary result of such sliding may be illustrated in FIG. 3C.

Referring now to the exemplary embodiment of FIG. 3C, an exemplary handle 60 may be situated such that pin 53 has been positioned in the opposite side of the slot 61 from where it began in FIG. 3A. As illustrated in FIG. 3D, an exemplary surface 63 of handle 60 may be in flush contact with staggered wall 52b of cavity 52 in container 50. Surface 62 may be shown outside of the groove 52d. With sufficient downward force on the portion of an exemplary handle 60 beyond surface 52a of container 50, an exemplary surface 62 may be disposed within the groove 52d of the storage container 50 to allow the exemplary handle 60 to remain in an extended position that is substantially orthogonal to the cavity surface 52c and container surface 52a.

Combining the various disclosures of the embodiments illustrated in FIGS. 2A-B and 3A-D, an exemplary storage container 50 may contain at least two cavities 51 and 52 for housing components used for rearrangement, carrying, and storage of contents, namely, arms 30 of locking mechanisms 20 and handles 60. As such, an exemplary storage container 50 may be more easily moved and stored without sacrificing space due to the fact that arms 30 of the locking mechanisms 20 may be nested away from the outer surface 52a while the handles 60 may be stored away from the outer surface 52a by resting within cavity 52 adjacent wall 52c. In other words, one or more of the exemplary embodiments illustratively provided for herein may achieve substantial space savings and ease of storage within a particular space 100 while also permitting repeated locking between the storage container 50 with the space 100 via known locking anchors 10A-C.

Many further variations and modifications may suggest themselves to those skilled in art upon making reference to above disclosure and foregoing interrelated and interchangeable illustrative embodiments, which are given by way of example only, and are not intended to limit the scope and spirit of the interrelated embodiments of the invention described herein.

1. A storage container, comprising:
an outer surface and an inner surface, the inner surface configured to receive an object therein, and the outer surface having an outer side surface and a bottom surface;
at least one first cavity in one of the outer side surface and the bottom surface; and
at least one locking mechanism disposed in the at least one first cavity, wherein the locking mechanism comprises a rotatable key for reception within an anchor having a corresponding opening for said key, and an arm extending outwardly from the locking mechanism that is configured to rotate the key, the arm spanning a distance that is bounded by the at least one first cavity.

2. The storage container of claim 1, wherein the at least one first cavity is located on the bottom surface of the storage container.

3. The storage container of claim 2, further comprising at least one second cavity located on the bottom surface opposite the location of the at least one first cavity, the at least one second cavity comprising a locking mechanism having at least one arm configured to rotate a rotatable key of the locking mechanism.

4. The storage container of claim 1, wherein the at least one first cavity is located on the bottom surface of the storage container and the storage container comprises at least one second cavity located on the outer side surface of the storage container.

5. The storage container of claim 4, further comprising an adjustable handle hingedly coupled to the storage container within the at least one second cavity, wherein the handle comprises a slot in which a portion of the storage container may travel and a surface on the handle most proximal to the at least one second cavity that enables substantially orthogonal and fixed placement of the handle vis-à-vis the outer surface of the storage container.

6. The storage container of claim 5, further comprising at least one third cavity located on the bottom surface opposite the location of the at least one first cavity, the at least one second cavity comprising a locking mechanism having at least one arm configured to rotate a rotatable key of the locking mechanism.

7. The storage container of claim 6, further comprising at least one fourth cavity located on the outer side surface opposite the location of the at least one second cavity, the at least one fourth cavity comprising an adjustable handle hingedly coupled to the storage container within the at least one fourth cavity.

8. The storage container of claim 5, wherein the locking mechanism in the at least one first cavity and the locking mechanism in the at least one second cavity are located along a line that is substantially collinear with a major horizontal dimension of the storage container.

9. The storage container of claim 7, wherein the locking mechanism in the at least one first cavity and the locking mechanism in the at least one third cavity are located along a line that is substantially collinear with a major horizontal dimension of the storage container.

10. The storage container of claim 7, wherein the locking mechanism in the at least one first cavity and the locking mechanism in the at least one third cavity are located along a line that is substantially collinear with a line that divides each handle in half.

11. The storage container of claim 1, further comprising an adjustable handle hingedly coupled to the storage container within the at least one second cavity.

12. The adjustable handle of claim 11, further comprising a slot through the handle surface, the slot being configured for holding an accessory.

13. The adjustable handle of claim 12, wherein the slot has a hexagonal cross-section.

14. The adjustable handle of claim 11, wherein the handle comprises at least one surface for engaging a ridge on the storage container to inhibit movement of the handle.

15. The adjustable handle of claim 14, wherein the at least one surface is a plurality of spherical projections for frictionally engaging the ridge.
